(19) United States
(12) Patent Application Publication
(10) Pub. No.: US 2011/0072483 A1
(43) Pub. Date: Mar. 24, 2011

(54) Multi-medium system

(75) Inventor: Chi-Chen CHENG, Taipei City (TW)

(73) Assignee: iPeerMultimedia International Ltd, Taipei City (TW)

(21) Appl. No.: 12/240,413

(22) Filed: Sep. 29, 2008

(30) Foreign Application Priority Data
Oct. 11, 2007 (TW) 096217006

(51) Int. Cl. H04N 7/173

(52) U.S. Cl. 725/117

(57) ABSTRACT

A multi-medium system includes a multi-medium data provider, a player and a relay device. The multi-medium data provider includes an audio database, a lyric database, a static video database and a dynamic video database. The player includes a driver software unit, a memory unit connected to the driver software unit, an input unit connected to the driver software unit and an output unit connected to the driver software unit. The relay device is used to connect the multi-medium data provider to the player so that the multi-medium data provide provides multi-medium data to the player through the relay device without the need to store the multi-medium data in the relay device.

### BACKGROUND OF INVENTION

1. Field of Invention

The present invention relates to a multi-medium system and, more particularly, to an efficient and secure multi-medium system.

2. Related Prior Art

Referring to FIG. 1, there is shown a conventional multi-medium system including a web site 6, the Internet 5, a computer 4 and a player 7. The web site 6 provides multi-medium data to the computer 4 through the Internet 5. The computer 4 instructs the player 7 to play the multi-medium data. The player 7 might be an MP3 player or a DVD player. There are problems with this conventional multi-medium system. Firstly, the operation is slow because the computer 4 must receive and store the multi-medium data and the player 7 also must receive and store the multi-medium data. Secondly, the operation causes a heavy burden on the computer 4 because the computer 4 must store and run the driver software for the player 7. Thirdly it is easy to steal the multi-medium data from the computer 4.

The present invention is therefore intended to obviate or at least alleviate the problems encountered in prior art.

### SUMMARY OF INVENTION

It is the primary objective of the present invention to provide an efficient and secure multi-medium system.

To achieve the foregoing objective, the multi-medium system includes a multi-medium data provider, a player and a relay device. The multi-medium data provider includes an audio database, a lyric database, a static video database and a dynamic video database. The player includes a driver software unit, a memory unit connected to the driver software unit, an input unit connected to the driver software unit and an output unit connected to the driver software unit. The relay device is used to connect the multi-medium data provider to the player so that the multi-medium data provide provides multi-medium data to the player through the relay device without the need to store the multi-medium data in the relay device.

Other objectives, advantages and features of the present invention will become apparent from the following description referring to the attached drawings.

### BRIEF DESCRIPTION OF DRAWINGS

The present invention will be described via the detailed illustration of the preferred embodiment referring to the drawings.

FIG. 1 is a block diagram of a conventional multi-medium system.

FIG. 2 is a perspective view of a multi-medium system according to the preferred embodiment of the present invention.

FIG. 3 is a block diagram of the multi-medium system shown in FIG. 2.

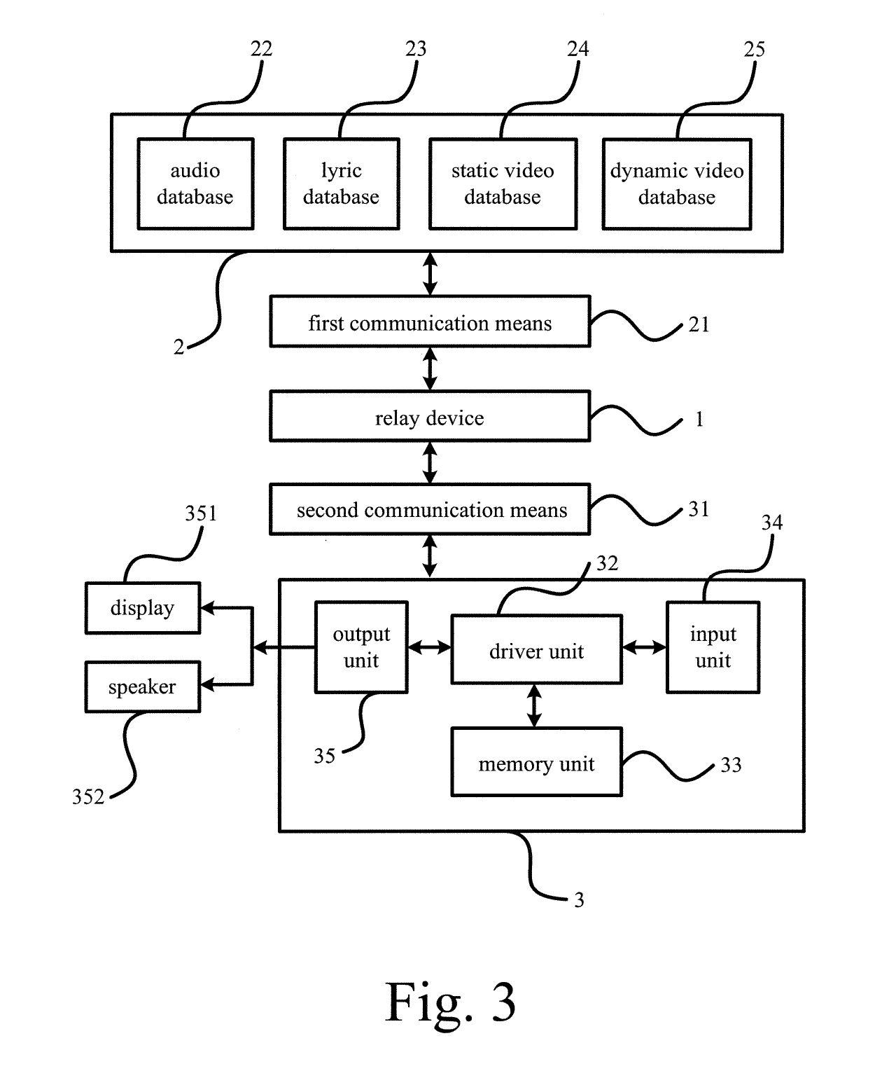

### DETAILED DESCRIPTION OF PREFERRED EMBODIMENT

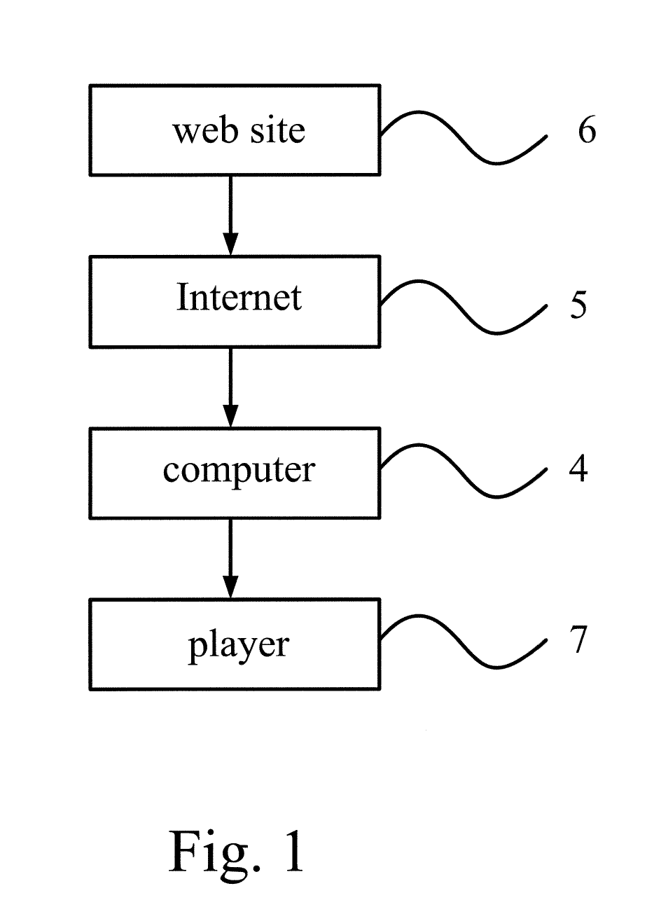

Referring to FIG. 1, a multi-medium system includes a relay device 1, a multi-medium data provider 2 and a player 3 according to the preferred embodiment of the present invention.

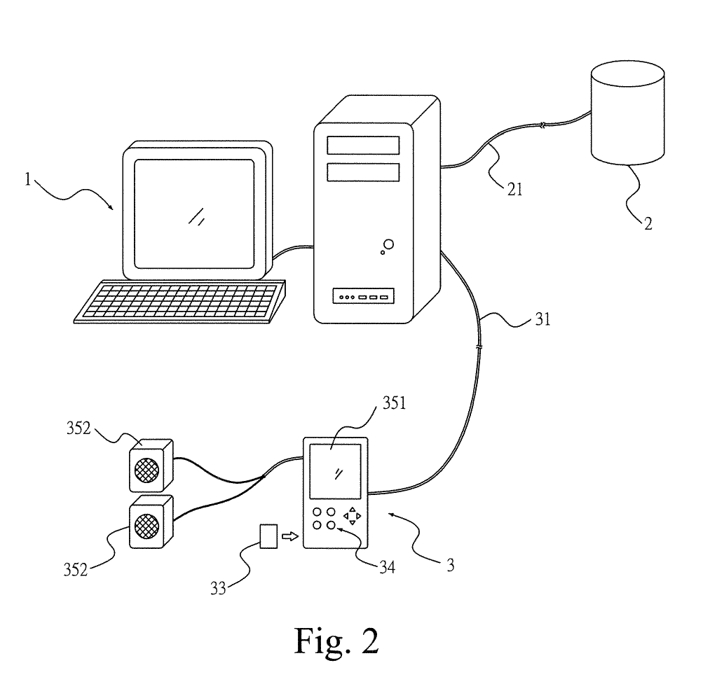

Referring to FIGS. 1 and 2, the relay device 1 might be a browsing device, a computer, a mobile phone or a PDA. The relay device 1 is preferably a computer.

The multi-medium data provider 2 might be a website or a server for providing multi-medium data. The multi-medium data provider 2 includes an audio database, a lyric database 23, a static video database 24 and a dynamic video database 25. The multi-medium data provider 2 is connected to the relay 1 through first communication means 21 such as a cable, a wire net, a wireless net, the infrared transmission and the Bluetooth communication.

The player 3 includes a driver software unit 32, a memory unit 33 connected to the driver software unit 32, an input unit 34 connected to the driver software unit 32 and an output unit 35 connected to the driver software unit 32. The input unit 34 includes keys or buttons operable to provide instructions and/or data to the player 3. The output unit 35 is connected to a display 351 and two speakers 352. The player 3 is connected to the relay device 1 through second communication means 31 such as a cable, a wire net, a wireless net, the infrared transmission and the Bluetooth communication.

In use, the multi-medium data provider 2 provides the multi-medium data to the player 3 through the relay device 1. The relay device 1 enables a user to use the relay device 1 or the player 3 to access to the multi-medium data provider 2 without the need to store the driver software for the player 3. The user can order some of the data stored in the audio database 22, the lyric database 23, the static video database 24 and the dynamic video database 25. After the order is completed, the multi-medium data provider 2 provides the multi-medium data to the player 3 through the relay device 1. The relay device 1 does not store the multi-medium data. There is no burden on the memory of the relay device 1. Moreover, it is more difficult to steal the multi-medium data from the player 3 than the relay device 1. The edition, naming, transfer and playing of the multi-medium data is monitored from the display 351 and/or the speakers 352. The user might design his or her own interface for the player 3 and proceed with the customization of the player 3. There are some advantages of the multi-medium system. Firstly, the operation is efficient because there is no need to store the driver software for the player 3 and the multi-medium data in the relay device 1. Secondly, the operation is secure because it is difficult to steal the multi-medium data from the player 3.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A multi-medium system comprising:
a multi-medium data provider comprising an audio database, a lyric database, a static video database and a dynamic video database;
a player comprising a driver software unit, a memory unit connected to the driver software unit, an input unit connected to the driver software unit and an output unit connected to the driver software unit; and
a relay device for connecting the multi-medium data provider to the player so that the multi-medium data provide provides multi-medium data to the player through the relay device without the need to store the multi-medium data in the relay device.

2. The multi-medium system according to claim 1, wherein the relay device is a browsing device.

3. The multi-medium system according to claim 1, wherein the relay device is a computer.

4. The multi-medium system according to claim 1, wherein the relay device is a mobile phone.

5. The multi-medium system according to claim wherein the relay device is a computer.

6. The multi-medium system according to claim 1 comprising communication means for connecting the multi-medium data provider to the relay device.

7. The multi-medium system according to claim 6, wherein the communication mans is a cable

8. The multi-medium system according to claim 6, wherein the communication mans is a wire net.

9. The multi-medium system according to claim 6, wherein the communication mans is a wireless net.

10. The multi-medium system according to claim 6, wherein the communication mans is the infrared transmission.

11. The multi-medium system according to claim 6, wherein the communication mans is the Bluetooth communication.

12. The multi-medium system according to claim 1 comprising communication means for connecting the player to the relay device.

13. The multi-medium system according to claim 12, wherein the communication mans is a cable.

14. The multi-medium system according to claim 12, wherein the communication mans is a wire net.

15. The multi-medium system according to claim 12, wherein the communication mans is a wireless net.

16. The multi-medium system according to claim 12, wherein the communication mans is the infrared transmission.

17. The multi-medium system according to claim 6, wherein the communication mans is the Bluetooth communication.

18. The multi-medium system according to claim 1, wherein the input unit comprises keys operable to provide data to the player.

19. The multi-medium system according to claim 1, wherein the output unit comprises a display and two speakers.
